(19) United States
(12) Patent Application Publication
(10) Pub. No.: US 2003/0213851 A1
(43) Pub. Date: Nov. 20, 2003

(54) Non-inertial thermostat and non-inertial thermostat/humidistat for building climate and energy consumption control

(76) Inventors: Alexander L. Burd, Suffield, CT (US); Galina S. Burd, Suffield, CT (US)

Correspondence Address: Mr. Alexander L. Burd, 3 Braintree Court, Suffield, CT, 06078, US

(21) Appl. No.: 10/150,910

(22) Filed: May 20, 2002

(51) Int. Cl. G05D 23/00

(52) U.S. Cl. 236/44 A; 236/51

(57) ABSTRACT

The present invention is related to a wide variety of thermostats and thermostats/humidistats for air temperature and relative humidity control in buildings having heating, cooling and humidification systems. We suggest using a forced air device to take a representative air sample near the building occupant's location in order to enhance indoor climate control and improve its accuracy. When this forced air device is used, the existing standard thermostat or standard thermostat/humidistat becomes a non-inertial thermostat or thermostat/humidistat. We also suggest to equip non-inertial programmable thermostat or thermostat/humidistat as well as standard programmable thermostat or thermostat/humidistat with an advisory computing system. This system will provide the occupant with a guiding tool and enable him to make an informative decision about set points selection in relation to the projected energy savings or energy over-consumption at particular mode of operation, as compared to the base set points. The invention is applicable for stationary as well as mobile thermostat or thermostat/humidistat.

### BACKGROUND OF THE INVENTION

This invention is related to indoor climate control of heating and cooling systems, which are used to provide comfort in residential houses, institutional, commercial, industrial and other buildings. All these buildings have heating and/or cooling plant and heating and/or cooling units in each room where comfort conditions should be maintained. Presently, the indoor climate is controlled by existing inertial thermostat or thermostat/humidistat (standard thermostat or standard thermostat/humidistat). The control is implemented by taking the air sample at the standard thermostat or standard thermostat/humidistat location that is not representative of the indoor climate conditions at the occupant's location. Presently, the occupant does not have any information to evaluate projected energy consumption for the selected temperature set point. This prevents the occupant from making informative decisions about control parameters set point selection, limits his choices and leads to energy over-consumption.

In this invention the temperature and/or temperature/humidity control is suggested to be implemented utilizing either non-inertial stationary or non-inertial mobile thermostat or thermostat/humidistat. The non-inertial stationary or non-inertial mobile thermostat or non-inertial thermostat/humidistat are designed to use a representative air sample near the occupant's location. This enhances flexibility of climate control and enables the building's occupant to maintain optimal indoor climate parameters at the occupant's location and to save energy.

### BRIEF SUMMARY OF THE INVENTION

The present invention is related to air temperature control for buildings with plurality of space heating/humidification and cooling systems, which include central building heating and/or cooling source, such as boiler, chiller, forced air furnace, air handling unit, or individual heating/cooling source, etc. and which have at least one non-inertial thermostat or non-inertial thermostat/humidistat with a special forced air device to take a representative air sample from the occupant's location to enhance climate control in the building. The suggested non-inertial thermostat or non-inertial thermostat/humidistat could be either stationary or mobile; the latter is intended to provide flexible room air climate control at any building location, which is critical at the particular time, including the rooms, which do not have any thermostats or thermostats/humidistats. This non-inertial mobile thermostat or thermostat/humidistat has an authority, if necessary, to override control of any other thermostat or thermostat/humidistat at any time and, therefore, to control room space heating and/or space cooling at any particular location to provide a required comfort in any room in the building on demand. The non-inertial stationary or mobile thermostat or thermostat/humidistat generates multiple signals which are transmitted to a receiver/controller, which is installed on central building space heating and/or space cooling plant or on room space heating and/or space cooling unit, or at other locations. Signals through receiving and control means change heating/humidity or cooling output capacity at a building plant or room unit responsively to the signal from the non-inertial stationary or mobile thermostat or thermostat/humidistat to maintain a room air temperature/humidity at the particular location in compliance with temperature/humidity set point of the non-inertial stationary or mobile thermostat or thermostat/humidistat.

The stationary and, particularly, mobile thermostats allow the occupant to control climate conditions in close proximity to the occupant. This control also gives the occupant ability to have a real and frequent impact on energy consumption in the house as well. The value of the temperature set point directly impacts the annual energy consumption in the house. Not only this energy consumption depends on the temperature set point at any particular time, but it is also a function of the occupant's location within the house (for instance, on the first, second or the third floor of the residential house controlled from non-inertial mobile thermostat). The energy consumption also depends on the climatic conditions. Considering importance of the informative decision made by the occupant regarding energy consumption and its cost, we suggest to equip the stationary and/or mobile thermostat or thermostat/humidistat with a computing tool to guide the occupant.

This tool will serve the occupant as a guide, which will help the occupant to understand better how the set point temperature selection would influence energy consumption in the house. The increase or reduction in energy consumption will be calculated in relation to the base temperature set points for heating and/or cooling.

The following example demonstrates importance of the suggested energy conservation computing guide. Let us assume that in heating mode of operation the base set point temperature for the thermostat is 72° F. Increase of this set point temperature by 1° F. will increase the annual energy consumption in the building (assuming that this is one story ranch) by 3%. The same increase in the temperature set point, when the occupant is on the first floor (assuming that the occupant is in a two-story house), will increase the annual space heating energy consumption by 4% due to the second floor overheating because of the natural convection impact, etc.). Therefore, it appears quite important to have the energy consumption guideline that is available for the occupant on demand, since the occupant might frequently change the thermostat set point, especially for mobile thermostat, adjusting it to the desirable comfort conditions at different locations in the house. When using a stationary thermostat, the occupant will always maintain the set point with a safety factor in mind to guarantee comfortable conditions, however, when using a mobile thermostat, the occupant will change the thermostat's set point based on the occupant's location in the house. For instance, the comfortable climate conditions near a window might differ from the comfortable climate conditions in the middle of the room, etc. Therefore, the occupant will have an opportunity to select the best comfort mode with clear understanding how this comfort level might affect energy consumption and increase or reduce occupant's monthly energy bill. In this respect, application of the thermostat, equipped with the computing guide, will further advance and promote energy conservation in buildings. In addition, the suggested system might also include relative humidity control.

Two conditions should be satisfied in order for climate control system to be successful in operation. First, the climate control system sensitive element (i.e., thermostat or thermostat/humidistat) shall be exposed to a representative air sample which is taken as close as possible to the occupant and shall instantly respond to a change in climate at the occupant's and thermostat's or thermostat/humidistat's location and generate a control signal for a heating/cooling plant to change its output capacity in response to the changed climate conditions at the thermostat's or thermostat/humidistat's location. Second, the heating/cooling plant or system shall be able to adjust its output timely to satisfy climate conditions at the occupant's and thermostat's or thermostat/humidistat's location on demand with required accuracy to minimize deviation of the climate conditions from the thermostat or thermostat/humidistat set point.

The suggested control system addresses these issues. The system might include a non-inertial mobile thermostat or non-inertial mobile thermostat/humidistat which will allow the occupant to optimize temperature and relative humidity parameters on demand, while moving the non-inertial mobile thermostat or non-inertial mobile thermostat/humidistat to different areas of the building. By definition, the non-inertial mobile thermostat or non-inertial mobile thermostat/humidistat differs from any other thermostat and/or humidistat because it has to react immediately to a temperature and/or humidity change at its location in order to satisfy the user's requirements. This can be achieved by utilizing a non-inertial mobile thermostat or non-inertial mobile thermostat/humidistat.

The non-inertial mobile thermostat or non-inertial mobile thermostat/humidistat will have a special forced air device, which will quickly move an air sample from the occupant's location to the sensitive elements of the thermostat or thermostat/humidistat. The forced air device could be maintained at a constant or variable air flow settings and its operation can be arranged in such a way, that the room air sample will be taken from vertical air layers or horizontal air layers or both. The direction of the flow with air sample can be adjusted manually or automatically, allowing for a pinpoint climate control at any location in the room. Furthermore, the non-inertial mobile thermostat or non-inertial mobile thermostat/humidistat will be able to give the occupant a better control of the indoor climate conditions by analyzing the air samples that are representative to the occupant's position. This is important for the occupant's comfort because of the existence of significant vertical and horizontal temperature variations within the same room. For instance, if the occupant is using a non-inertial mobile thermostat or non-inertial mobile thermostat/humidistat is in a vertical position, the non-inertial mobile thermostat or non-inertial mobile thermostat/humidistat shall be also located vertically. When the occupant is using the non-inertial mobile thermostat or non-inertial mobile thermostat/humidistat is in horizontal position, the non-inertial mobile thermostat or non-inertial mobile thermostat/humidistat shall be also located horizontally. This will lead to the non-inertial mobile thermostat or non-inertial mobile thermostat/humidistat instant and accurate reaction to any air temperature or humidity change at the occupant's location, improve the entire system controllability and reduce its annual energy consumption.

Stationary thermostat or thermostat/humidistat will also benefit from becoming a non-inertial stationary thermostat or non-inertial thermostat/humidistat. This will allow, for example, taking an air sample from below or from the above of the thermostat or thermostat/humidistat in winter or in summer, respectively, to address vertical air temperature variation in the building. As a result, the utilization of the forced air device in the non-inertial stationary thermostat or non-inertial stationary thermostat/humidistat will reduce the cycling, stabilize and optimize operation of the entire heating and/or cooling system and reduce its annual energy consumption.

### BRIEF DESCRIPTION OF THE DRAWINGS

FIG. 1 shows the principle schematics and control signals of the non-inertial stationary or mobile thermostat system.

FIG. 2 shows the principal schematics and control signals of the non-inertial stationary or non-inertial mobile thermostat/humidistat system.

FIG. 3 shows the principal schematics and control signals of the non-inertial mobile thermostat system that is capable to use two channels to control two zones of the building or the areas in two different buildings from the same non-inertial mobile thermostat.

FIG. 4 shows the principal schematics and control signals of the non-inertial mobile thermostat/humidistat system that is capable to use two channels to control two zones of the building or the areas in two different buildings from the same mobile thermostat/humidistat

FIG. 5 shows the principal diagram of the heating/humidification and cooling system with non-inertial stationary or non-inertial mobile thermostat/humidistat to control climate in two zones of the same building.

FIG. 6 shows the principal diagram of the heating/humidification and cooling system with non-inertial stationary or non-inertial mobile thermostat/humidistat to control climate in two buildings.

FIG. 7 shows the location of the non-inertial mobile thermostat or non-inertial mobile thermostat/humidistat with respect to the position of the occupant in the room.

### DETAILED DESCRIPTION OF THE INVENTION

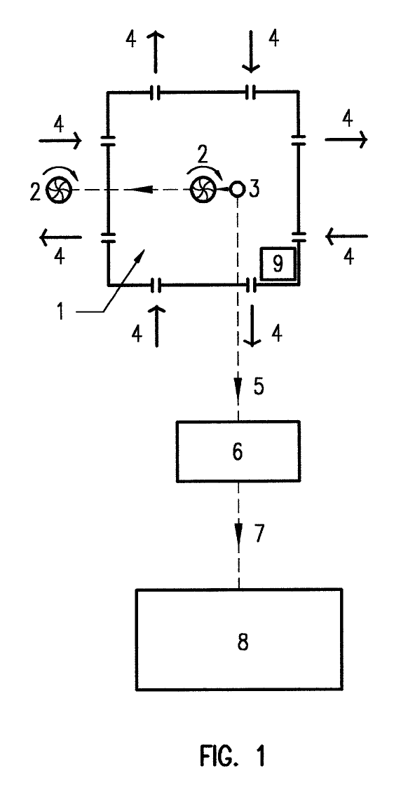

The principle schematics and control signals of the non-inertial stationary or mobile thermostat system are shown in FIG. 1. In FIG. 1, reference numerals denote as follows:

1—non-inertial stationary or non-inertial mobile thermostat to control temperature;

2—alternative locations of air-moving device inside or outside of thermostat enclosure to force the air flow towards temperature sensitive element;

3—temperature sensitive element;

4—air sample;

5—temperature signal;

6—receiver/controller;

7—temperature control signal;

8—heating and/or cooling system;

9—parameters set points and energy consumption advisory system.

The non-inertial stationary or non-inertial mobile thermostat 1 has an air-moving device 2 located inside or outside of the thermostat. The air-moving device forces the air sample from the room to flow through openings 4 towards the temperature sensitive element 3. The air can flow to and from the thermostat through openings 4. The air flow direction can be adjusted manually or automatically. When the temperature measured by the thermostat's temperature sensitive element differs from its set point (high or low values), for instance, is higher or lower than the thermostat's set point, the thermostat generates the signal 5. The signal is sent to receiver/controller 6. Simultaneously, the signal is sent to an air-moving device 2 to turn it on. The controller generates control signal 7 that is proportional to the temperature difference between the thermostat set point and the actual temperature at the thermostat's location. The signal is then sent from the controller to the heating and/or cooling system 8 to reduce or increase its output capacity in order to satisfy set point temperature at the non-inertial stationary or non-inertial mobile thermostat location. When the temperature at the thermostat location is satisfied and equals to its set point, the thermostat sends a signal to turn the air moving device 2 off. The non-inertial stationary or mobile thermostat also has means for parameters set points selection and energy consumption advisory system—a computer 9, which calculates potential energy savings or energy over-consumption each time the tenant changes the thermostat's set point. Parameters' set point allows changing set points of control parameters, and also, for example, to turn the building's heating and/or cooling air distribution fan or hot/chilled water pump on or set it for automatic mode of operation, etc. The computer calculates percentage of annual energy savings at a given mode of operation with relation to the thermostat set point temperature per each degree of the temperature differences between the base temperature set point and actual selected set point temperature. The projected energy consumption will be calculated per each degree of increase or reduction in air temperature set point as compared to the base set point temperature value. The energy savings (−ES) or energy over consumption (+ES) for heating and/or cooling operations at the particular outdoor climate conditions will be calculated from the following equation:

±ES=N×(±ΔEC/BEC)×100, %

where:

N—number of degrees F. (degrees C.) indicating increase or lowering the thermostat's set point in relation to the base temperature set point;

±ΔEC—increase or reduction in energy consumption due to increase or reduction in thermostat's set point temperature by one degree F. (one degree C.) as compared to the base set point temperature;

BEC—energy consumption for the thermostat's base set point temperature.

The same formula could be used to calculate energy consumption for the programmable thermostats considering various temperature set points (i.e., temperature set back and set forward) and their duration during a day. The computer also calculates energy savings or energy over-consumption with relation to the thermostat's location, for instance, for the non-inertial stationary or non-inertial mobile thermostat control when the thermostat is located on the second or third floor of the house, as opposed to the first floor.

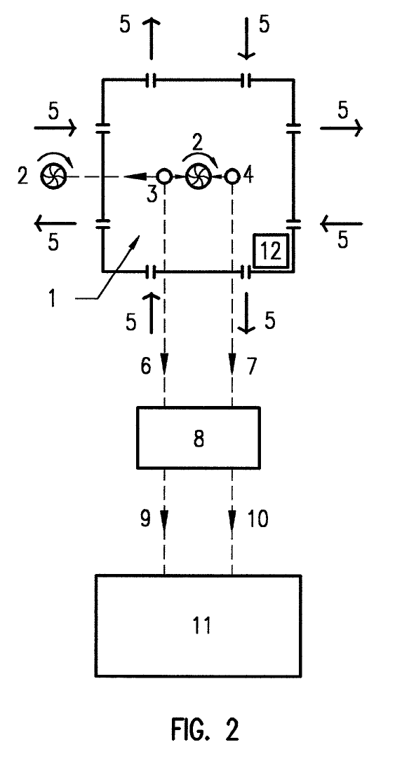

The principal schematics and control signals of the non-inertial stationary or non-inertial mobile thermostat/humidistat system are shown in FIG. 2. In FIG. 2, reference numerals denote as follows:

1—non-inertial stationary or non-inertial mobile thermostat/humidistat to control climate;

2—alternative locations of air-moving device inside or outside of thermostat/humidistat enclosure to force the air flow towards temperature/humidity sensitive elements;

3—temperature sensitive element;

4—humidity sensitive element;

5—air sample;

6—temperature signal;

7—humidity signal;

8—receiver/controller;

9—temperature control signal;

10—humidity control signal;

11—heating/humidity and/or cooling system;

12—parameters set points and energy consumption advisory system.

The non-inertial stationary or non-inertial mobile thermostat/humidistat 1 has an air-moving device 2 located inside or outside of the thermostat. The air-moving device forces room air sample to flow through openings 5 towards the temperature sensitive element 3 and the humidity sensitive element 4. The air can flow in and out of the non-inertial mobile thermostat/humidistat through openings 5. The direction of air flow can be adjusted manually or automatically. When the temperature and/or relative humidity level measured by the temperature/humidity sensitive elements differ from their set point (high or low values), for instance, is higher or lower than the thermostat/humidistat's set point, the thermostat generates the signal 6 and the humidistat generates the signal 7. The signals are sent to the receiver/controller 8. Simultaneously, the signal is sent to an air-moving device 2 to turn it on. The controller sends the control signal 9, which is proportional to the said temperature difference to the heating and/or cooling system 11. The controller sends the control signal 10, which is proportional to the said relative humidity difference to the humidity control system 11. The signals are sent to the heating and/or cooling system 11 to reduce or increase their output capacity in order to satisfy temperature and/or relative humidity set points at the non-inertial stationary or non-inertial mobile thermostat/humidistat location. When the temperature/relative humidity at the thermostat/humidistat location equals to their set points, the non-inertial stationary or non-inertial mobile thermostat/humidistat sends a signal to turn the air-moving device 2 off. The non-inertial thermostat/humidistat have a priority control selection mode. The occupant can select a priority mode for both temperature and relative humidity control or for temperature control only. Under the both temperature and relative humidity priority control mode the thermostat/humidistat will operate until the temperature and the relative humidity level at the thermostat/humidistat location are satisfied. Under the temperature priority control mode the system will operate until the temperature at the thermostat/humidistat location is satisfied. The non-inertial stationary or non-inertial mobile thermostat/humidistat also has means for parameter's set points selection and energy consumption advisory system—a computer 12 that calculates potential energy savings or energy over-consumption each time the occupant changes the thermostat's set point. Parameters' set points allow to change set points of control parameters, and also to turn the building's heating/cooling air distribution fan or hot/chilled water pump on or set it for automatic mode of operation, etc. The computer calculates percentage of annual energy savings at a given mode of operation with relation to the thermostat set point temperature per each degree of the temperature differences between the base temperature set point and actual set point temperature. The computer also calculates energy savings for the mobile thermostat control when the thermostat is located, for instance, on the second or third floor of the house, as opposed to the first floor.

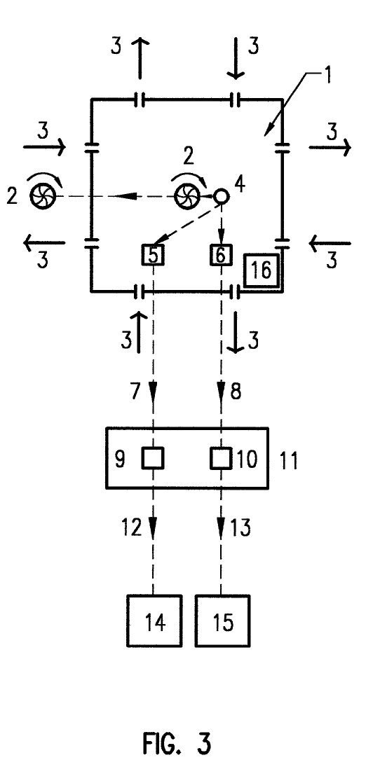

The principal schematics and control signals of the non-inertial mobile thermostat system that is capable to use two channels to control two zones of the building or the areas in two different buildings from the same non-inertial mobile thermostat are shown in FIG. 3. In FIG. 3, reference numerals denote as follows:

1—non-inertial mobile thermostat to control temperature,

2—alternative locations of air-moving device inside or outside of thermostat enclosure to force the air flow towards temperature sensitive element;

3—air sample;

4—temperature sensitive element;

5—channel #1 of non-inertial mobile thermostat;

6—channel #2 of non-inertial mobile thermostat,

7—temperature signal from channel #1 of non-inertial mobile thermostat;

8—temperature signal from channel #2 of non-inertial mobile thermostat;

9—channel #1 of receiver/controller,

10—channel #2 of receiver/controller;

11—receiver/controller;

12—temperature control signal from channel #1 of controller;

13—temperature control signal from channel #1 of controller;

14—heating and/or cooling system of zone #1;

15—heating and/or cooling system of zone #2;

16—parameters set points and energy consumption advisory system.

The non-inertial mobile thermostat 1 has an air-moving device 2 located inside or outside of the thermostat. The air-moving device forces the air sample from the room to flow through openings 3 towards the temperature sensitive element 4. The air can flow to and from the thermostat through openings 3. The direction of air flow can be adjusted manually or automatically. The non-inertial mobile thermostat has two channels 5 and 6 to send the signals to receiver/controller 11. This enables the thermostat to control two zones of the building (one zone at a time). When the temperature value, measured by the thermostat's temperature sensitive elements in the first or the second zones, differs from its set point (high or low values), for instance, is higher or lower than the thermostat's set point, the thermostat via the first channel generates the signal 7 or via the second channel generates the signal 8. These signals are sent to the receiver/controller. Simultaneously, the signal is sent to an air-moving device 2 to turn it on. The receiver/controller receives these signals via channels 9 and 10 and sends the control signals 12 and 13 that are proportional to the temperature difference between the thermostat's set point and the actual temperature at the thermostat's location. The signals then are sent to the heating and/or cooling system of zone #1 (numeral 14 in FIG. 3) and zone #2 (numeral 15 in FIG. 3) of the building to reduce or increase their output capacity in order to satisfy temperature set points at the non-inertial mobile thermostat location. When the temperature at the thermostat location is satisfied and equal to its set point the thermostat sends a signal to turn the air-moving device 2 off The non-inertial mobile thermostat also has means for parameters set points selection and energy consumption advisory system—a computer 16 that calculates potential energy savings or energy over-consumption each time the occupant changes the thermostat's set point. Parameters' set points allow to change set points of control parameters, and also to turn the building's heating/cooling air distribution fan or hot/chilled water pump on or set it for automatic mode of operation, etc. The computer calculates percentage of annual energy savings at a given mode of operation with relation to the thermostat set point temperature per each degree of the temperature differences between the base temperature set point and actual set point temperature. The computer also calculates energy savings with the mobile thermostat when the thermostat is located, for instance, on the second or third floor of the house as opposed to the first floor.

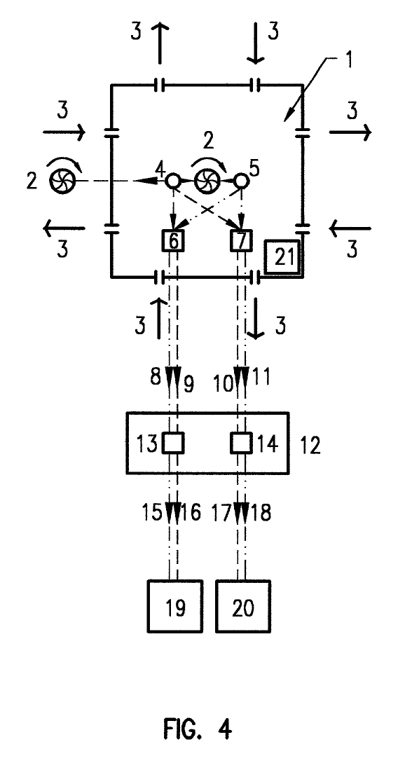

The principal schematics and control signals of the non-inertial mobile thermostat/humidistat system that is capable to use two channels to control two zones of the building or the areas in two different buildings from the same mobile thermostat/humidistat are shown in FIG. 4. In FIG. 4, reference numerals denote as follows:

1—non-inertial mobile thermostat/humidistat to control climate;

2—alternative locations of air-moving device inside or outside of thermostat/humidistat enclosure to force the air flow towards temperature/humidity sensitive elements;

3—air sample,

4—temperature sensitive element,

5—humidity sensitive element;

6—channel #1 of non-inertial mobile thermostat/humidistat;

7—channel #2 of non-inertial mobile thermostat/humidistat;

8—temperature signal from channel #1 of non-inertial mobile thermostat/humidistat;

9—humidity signal from channel #2 of non-inertial mobile thermostat/humidistat;

10—temperature signal from channel #2 of non-inertial mobile thermostat/humidistat;

11—humidity signal from channel #1 of non-inertial mobile thermostat/humidistat;

12—receiver/controller;

13—channel #1 of receiver/controller;

14—channel #2 of receiver/controller;

15—temperature control signal from channel #1 of controller;

16—humidity control signal from channel #1 of controller;

17—temperature control signal from channel #2 of controller;

18—humidity control signal from channel #2 of controller;

19—heating/humidity and/or cooling system of zone #1;

20—heating/humidity and/or cooling system of zone #2;

21—parameters set points and energy consumption advisory system.

The non-inertial mobile thermostat/humidistat 1 has an air-moving device 2 located inside or outside of the thermostat. The air-moving device forces the air sample from the room to flow through openings 3 towards the temperature sensitive element 4 and the humidity sensitive element 5. The air can flow to and from the thermostat/humidistat through openings 3. The non-inertial mobile thermostat/humidistat has two channels 6 and 7 to send the signals to the receiver/controller 12. This enables the non-inertial mobile thermostat/humidistat to control two zones of the building (one zone at a time). When the temperature and or relative humidity level in the first zone, measured by the thermostat's temperature/humidity sensitive elements, differs from their set points (high or low values), for instance, is higher or lower than the thermostat/humidistat set points, the thermostat generates the signal 8 and the humidistat generates the signal 9. The signals then are send via channel 6 to channel #1 (numeral 13 in FIG. 4) of the receiver/controller. Simultaneously, the signal is sent to an air-moving device 2 to turn it on. When the temperature and/or relative humidity level in the second zone measured by the thermostat's temperature/humidity sensitive elements differs from their set points, for instance, is higher or lower than the thermostat's set point, the thermostat generates the signal 10 and the humidistat generates the signal 11. The signals then via channel 7 are send to channel #2 (numeral 14 in FIG. 4) of the receiver/controller. The control signals 15, 16, 17 and 18 are then, sent via respective controllers 13 and 14 to the heating/humidity and/or cooling system 19 and 20. These control signals are proportional to the temperature and relative humidity differences between the thermostat/humidistat set points and temperatures/humidity levels at the thermostat/humidistat location to reduce or increase their output capacity in order to satisfy temperature and relative humidity set points at the non-inertial mobile thermostat/humidistat location. When the temperature/humidity at the thermostat/humidistat location is satisfied and equals to their set points the thermostat/humidistat sends a signal to turn the air-moving device 2 off. The non-inertial thermostat/humidistat have a priority control selection mode. The occupant can select a priority mode for both temperature and relative humidity control or for temperature control only. Under the both temperature and relative humidity priority control mode the thermostat/humidistat will operate until the temperature and the relative humidity at the thermostat/humidistat location are satisfied. Under the temperature priority control mode the thermostat/humidistat will operate until the temperature at the thermostat/humidistat location is satisfied. The non-inertial mobile thermostat/humidistat also has means for parameters set points selection and energy consumption advisory system—a computer 21, that calculates potential energy savings or energy over-consumption each time the tenant changes the thermostat's set point. Parameters' set points selection allows changing set points of control parameters, and also to turn the building's heating/cooling system air distribution fan or hot/chilled water pump on or set it on automatic mode of operation, etc. The computer calculates percentage of annual energy savings at a given mode of operation with relation to the thermostat set point temperature per each degree of the temperature differences between the base temperature set point and actual set point temperature. The computer also calculates energy savings for the mobile thermostat control when the thermostat is located, for instance, on the second or third floor of the house as opposed to the first floor.

The described above advisory computing system is not limited to the use in non-inertial thermostats or thermostats/humidistats only and can be utilized in any programmable thermostat or programmable thermostat/humidistat to assist the occupant in selecting optimal set point parameters based on the projected values of energy savings or energy over-consumption in relation to the base set point parameters.

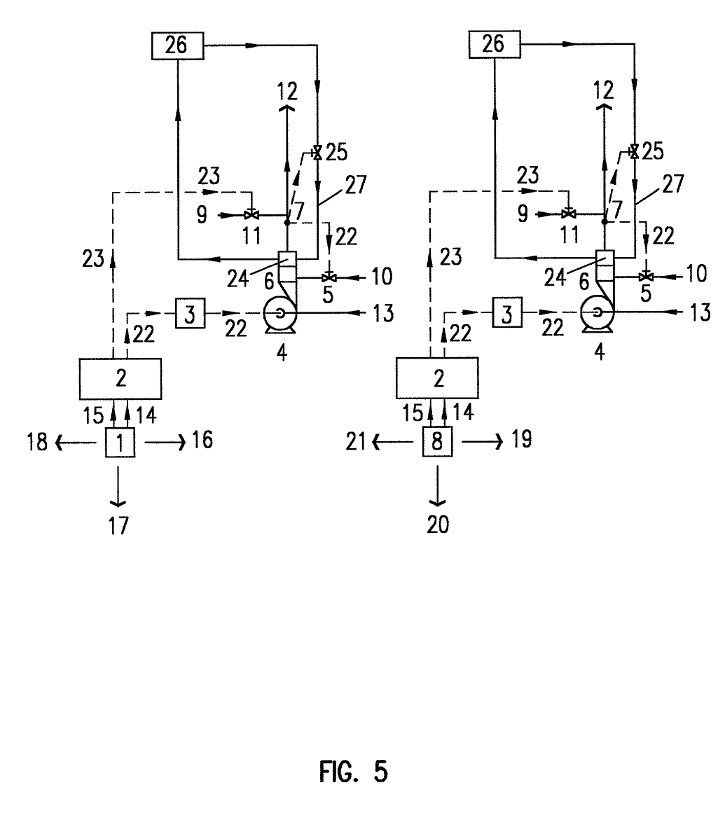

The principal diagram of the heating/humidification and cooling system with non-inertial stationary or non-inertial mobile thermostat/humidistat to control climate in two zones of the same building is shown in FIG. 5. In FIG. 5, reference numerals denote as follows:

1—non-inertial stationary or non-inertial mobile thermostat/humidistat to control climate in zone #1;

2—receiver/controller;

3—variable frequency drive control;

4—air distribution fan;

5—burner;

6—furnace;

7—discharged air temperature sensor;

8—non-inertial stationary or non-inertial mobile thermostat/humidistat to control climate in zone #2;

9—liquid to be added to the air for humidification;

10—fuel for furnace;

11—humidification control valve;

12—air distribution supply to zone #1 and zone #2 of building;

13—air distribution return from zone #1 and zone #2 of building;

14—temperature control signal;

15—humidity control signal;

16—room #1 in zone #1;

17—room #2 in zone #1;

18—room #3 in zone #1, etc.;

19—room #1 in zone #2;

20—room #2 in zone #2;

21—room #3 in zone #2, etc;

22—temperature control signal in zone #1 and zone #2;

23—humidity control signal in zone #1 and zone #2;

24—cooling coil in zone #1 and zone #2;

25—refrigerant control valve via cooling coil in zone #1 and zone #2;

26—compressor and condensing unit for zone #1 and zone #2;

27—refrigerant in zone #1 and in zone #2.

The non-inertial stationary or non-inertial mobile thermostat/humidistat 1 serving zone #1 of the building sends the temperature signal 15 when the temperature at the thermostat's location differs from the thermostat's set point and the humidity signal 14 when the relative humidity at the humidistat's location differs from the humidistat set point. These signals are sent to the receiver/controller 2. The receiver/controller sends the temperature control signal to the furnace 6 to turn it on/off or to the cooling coil 24 to turn it on/off. The control system of the furnace 6 and cooling coil 24 maintains a certain discharge air temperature by controlling the fuel flow rate 10 via burner control valve 5 to the furnace or by changing the cooling refrigerant 27 flow rate via the refrigerant control valve 25 and by controlling the compressor/condenser 26 operation. The temperature control signal 22 is proportional to the difference between the temperature at the non-inertial stationary or non-inertial mobile thermostat location and the thermostat's set point. This proportionality is realized in a multiple stage control. Under the first stage of control the flow rate via air distribution fan 4 varied with variable frequency drive 3 by speeding up or slowing down the fan's motor. If the temperature at the thermostat's location can not be satisfied within the first stage of the control, the controller 2 will cycle the furnace or the cooling coil on/off until the temperature set point at the thermostat's location is satisfied. The relative humidity control signal 23 is proportional to the relative humidity difference between the humidistat set point and the actual relative humidity value at the humidistat's location. The proportionality of the humidity control is realized by variation of the humidifying liquid 9 flow rate via control valve 11. The second non-inertial stationary or non-inertial mobile thermostat/humidistat 8 operates in a similar mode to the non-inertial mobile thermostat/humidistat 1. The only difference is that the non-inertial stationary or non-inertial mobile thermostat/humidistat 8 controls the zone #2 of the house. Obviously, non-inertial stationary thermostat/humidistat 1 in FIG. 5 can not be moved and is kept at the fixed location in the building. However, the same non-inertial mobile thermostat/humidistat 1 can be moved to any location within the rooms of the zone #1 such as room #1 identified by numeral 16 in FIG. 5, or room #2 identified by numeral 17 in FIG. 5, or room #3 identified by numeral 18 in FIG. 5. Obviously, non-inertial stationary thermostat/humidistat 8 in FIG. 5 can not be moved and is kept at the fixed location in the building. However, the same non-inertial mobile thermostat/humidistat 8 can be moved to any location within the rooms of the zone #2 such as room #1 identified by numeral 19 in FIG. 5, or room #2 identified by numeral 20 in FIG. 5, or room #3 identified by numeral 21 in FIG. 5.

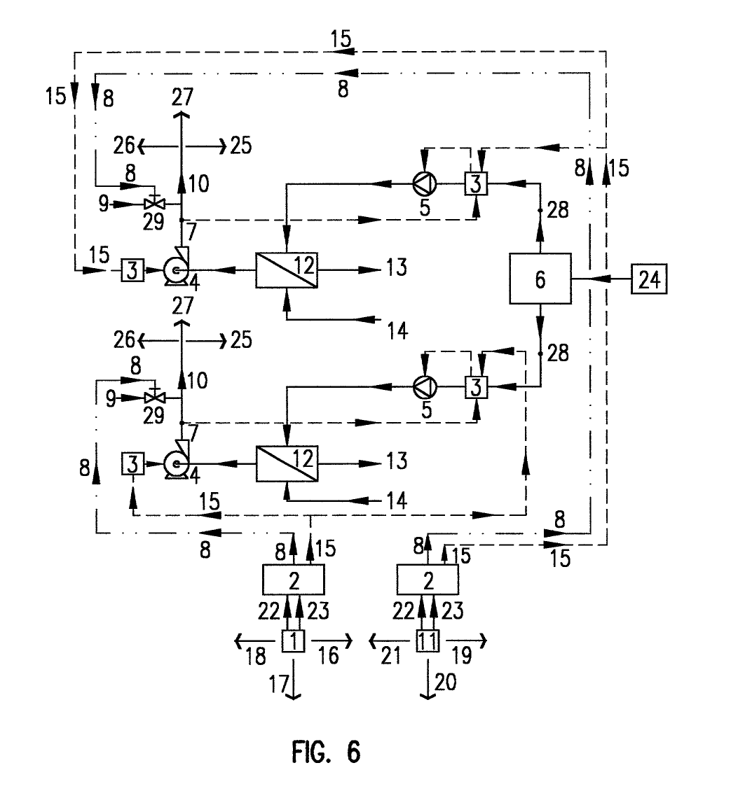

The principal diagram of the heating/humidification and cooling system with non-inertial stationary or non-inertial mobile thermostat/humidistat to control climate in two buildings are shown in FIG. 6. In FIG. 6, reference numerals denote as follows:

1—non-inertial stationary or non-inertial mobile thermostat/humidistat to control climate in building #1;

2—receiver/controller;

3—variable frequency drive control;

4—air distribution fan;

5—hot water/chilled water circulating pump;

6—boiler/chiller;

7—discharged air temperature sensor;

8—humidity control signal;

9—liquid to be added to the air for humidification;

10—air distribution supply to building #1 and building #2;

11—non-inertial stationary or non-inertial mobile thermostat/humidistat to control climate in building #2;

12—air handling unit;

13—hot water/chilled water return to boiler/chiller;

14—air distribution return from building #1 and building #2;

15—temperature control signal;

16—room #1 in building #1;

17—room #2 in building #1;

18—room #3 in building #1, etc.;

19—room #1 in building #2;

20—room #2 in building #2;

21—room #3 in building #2, etc;

22—temperature control signal;

23—humidity control signal;

24—variable frequency drive to control chiller's compressor or boiler's burner;

25—variable air volume box in room #1;

26—variable air volume box in room #2;

27—variable air volume box in room #3;

28—hot/chilled water temperature;

29—humidity control valve.

The non-inertial stationary or non-inertial mobile thermostat/humidistat 1 serving building #1 sends the temperature signal 23 when the temperature at the thermostat's location differs from the thermostat's set point and the humidity signal 22 when the relative humidity at the humidistat's location differs from the humidistat set point. These signals 22 and 23 are sent to the receiver/controller 2. The receiver/controller sends the temperature control signal to vary the capacity of the heating/humidity and cooling system. The control system of the boiler/chiller 6 maintains a certain supply hot/chilled water temperature by controlling the boiler or chiller mode of operation and increasing or reducing their output capacity. The temperature control signal 23 is proportional to the difference between the temperature at the non-inertial stationary or non-inertial mobile thermostat location and the thermostat's set point. This proportionality is realized in multiple stage control. Under the first stage of control the air flow rate via variable air volume box is changed (such as variable air volume boxes 25, 26, 27 in FIG. 6) in the room where the non-inertial stationary or non-inertial mobile thermostat/humidistat is located to satisfy the thermostat's set point. If the temperature at the thermostat's location can not be satisfied within the first stage of the control, the second stage of the control is initiated, and the controller 2 will send a signal to the variable frequency drive controlling the distribution air fan 4 to increase or reduce the air flow rate via the fan by speeding up or slowing down the fan's motor until the temperature set point at the thermostat's location is satisfied. If the temperature at the thermostat's location can not be satisfied within the second stage of control, the third stage of the control will be initiated. Under the third stage the discharge air temperature 7 will vary by changing the hot/chilled water flow rate via air handling unit 12 by speeding up or slowing down the water circulating pump 5. If the temperature at the thermostat's location can not be satisfied within the third stage of the control, the forth stage of the control is initiated to change the supply hot/chilled water temperature 28. This change in supply hot/chilled water temperature can be achieved by changing the boiler/chiller output via variable frequency drives to control the compressor of the chiller or the burner of the boiler. The humidity control signal 8 is proportional to the difference in relative humidity between the humidistat set point and the actual relative humidity value at the humidistat's location. The proportionality of humidity control is realized through variation of humidifying liquid 9 flow rate via control valve 29. The second non-inertial stationary or non-inertial mobile thermostat/humidistat 11 operates in a similar mode to the mobile non-inertial thermostat/humidistat 1. The only difference is that the non-inertial stationary or non-inertial mobile thermostat/humidistat controls the building #2. Obviously, non-inertial stationary thermostat/humidistat (1 and 11 in FIG. 6) can not be moved and is kept at the fixed location in the building. The non-inertial mobile thermostat/humidistat 1 can be moved to any location within the rooms of the building #1 such as room #1 identified by numeral 16 in FIG. 6, or room #2 identified by numeral 17 in FIG. 6, or room #3 identified by numeral 18 in FIG. 6. The non-inertial mobile thermostat/humidistat 11 can be moved to any location within the rooms of the building #2 such as room #1 identified by numeral 19 in FIG. 6, or room #2 identified by numeral 20 in FIG. 6, or room #3 identified by numeral 21 in FIG. 6.

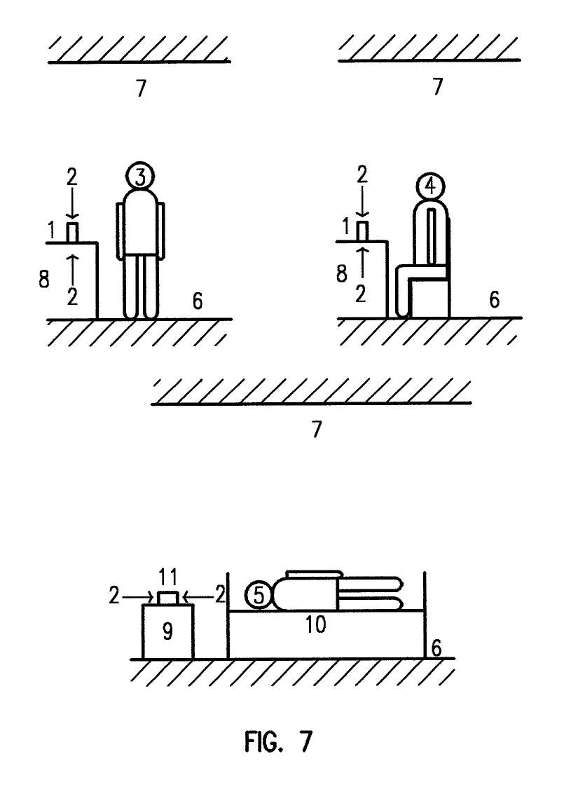

The location of the non-inertial mobile thermostat or non-inertial mobile thermostat/humidistat with respect to the position of the occupant in the room is shown in FIG. 7. In FIG. 7, reference numerals denote as follows:

1—non-inertial mobile thermostat or non-inertial mobile thermostat/humidistat in vertical position;

2—air sample;

3—occupant in vertical position (standing up);

4—occupant in vertical position (sitting down);

5—occupant in horizontal position (lying down);

6—floor;

7—ceiling,

8—table or desk;

9—night stand;

10—bed;

11—non-inertial mobile thermostat or non-inertial mobile thermostat/humidistat in horizontal position.

The non-inertial mobile thermostat or non-inertial mobile thermostat/humidistat with the forced air device could be placed vertically as shown by numeral 1 or horizontally as shown by numeral 2. The non-inertial mobile thermostat or non-inertial mobile thermostat/humidistat has a self-adjusted controllability when replicating the position of the occupant to provide for a better control of the climate at the occupant's location. For instance, when the occupant is standing up or sitting down in the chair, vertical positioning of the non-inertial mobile thermostat or non-inertial mobile thermostat/humidistat will allow for taking a more representative vertical air sample from the areas close to the occupant's feet and the occupant's head, therefore, providing for the better climate control at the occupant's level. On the other hand, when the occupant lies down on the bed, horizontal positioning of the non-inertial mobile thermostat or non-inertial mobile thermostat/humidistat will allow for taking a more representative horizontal air sample from the areas close to the occupant's body, therefore, providing better climate control at the occupant's level.

The preceding embodiment is representative of the invention. It is to be understood, however, that other expedients known to those skilled in the art or disclosed herein may be employed without departing from the spirit of the invention or the scope of the appended claims.

Having explained the invention what we claim as new is:

1. A building climate control for space heating and/or space cooling system having an individual or central heating/humidification and/or cooling sources, the said building having single room or a plurality of rooms serviced from the said individual or central heating/humidification and/or cooling sources, means to automatically change units heating/humidification and/or cooling capacity, the said rooms of the building having at least one non-inertial stationary thermostat or non-inertial mobile thermostat or non-inertial stationary thermostat/humidistat or non-inertial mobile thermostat/humidistat to control climate such as air temperature and air humidity to provide adequate heating and/or cooling to the rooms; the said non-inertial stationary thermostat or non-inertial mobile thermostat or non-inertial stationary thermostat/humidistat or non-inertial mobile thermostat/humidistat located at any place in the building, the said non-inertial stationary thermostat or non-inertial mobile thermostat or non-inertial stationary thermostat/humidistat or non-inertial mobile thermostat/humidistat having authority to control air temperature/humidity in any room in the building, means provided so that only one thermostat or thermostat/humidistat controls the air temperature at the particular room at any particular time, the said non-inertial stationary thermostat or non-inertial mobile thermostat or non-inertial stationary thermostat/humidistat or non-inertial mobile thermostat/humidistat having means responsive to the current room air temperature/humidity values at the location of the non-inertial stationary thermostat or non-inertial mobile thermostat or non-inertial stationary thermostat/humidistat or non-inertial mobile thermostat/humidistat, the said non-inertial stationary thermostat or non-inertial mobile thermostat or non-inertial stationary thermostat/humidistat or non-inertial mobile thermostat/humidistat having temperature or temperature/humidity set points means, such that when the air temperature/humidity in the room at the non-inertial stationary thermostat or non-inertial mobile thermostat or non-inertial stationary thermostat/humidistat or non-inertial mobile thermostat/humidistat location deviates from the said non-inertial stationary thermostat or non-inertial mobile thermostat or non-inertial stationary thermostat/humidistat or non-inertial mobile thermostat/humidistat temperature/humidity set points the said non-inertial stationary thermostat or non-inertial mobile thermostat or non-inertial stationary thermostat/humidistat or non-inertial mobile thermostat/humidistat generates multiple signals, the said signals are sent to the receiver/controller, the said receiver/controller having means to receive signals from the said non-inertial stationary or mobile thermostats or non-inertial stationary or mobile thermostats/humidistats and to send control signals to building central heating/humidifying and/or cooling system or to room heating/humidifying and/or cooling system, the said control signals are in proportion to the difference between the non-inertial stationary or mobile thermostat's temperature or non-inertial stationary or mobile temperature/humidity set points and the air temperature/humidity in the room at thermostat or thermostat/humidistat location, the said signals are sent to change the system's heating and/or cooling output capacity and the discharge air humidity to satisfy the non-inertial stationary or mobile thermostat or non-inertial stationary or mobile thermostat/humidistat air temperature/humidity set point requirements.

2. The control wherein the claim 1 is by a non-inertial stationary thermostat or non-inertial mobile thermostat or non-inertial stationary thermostat/humidistat or non-inertial mobile thermostat/humidistat which instantly responds to air temperature change in the room at non-inertial stationary or mobile thermostat or air temperature/humidity change at non-inertial stationary or mobile thermostat/humidistat location, said non-inertial stationary or mobile thermostat or non-inertial stationary or mobile thermostat/humidistat can be located on different surfaces (i.e., horizontally or vertically) of the different rooms inside of the building, said non-inertial stationary or mobile thermostat or non-inertial stationary or mobile thermostat/humidistat having electrical energy source from stationary electrical network or a battery energy source, including solar battery, etc., said non-inertial stationary or mobile thermostat or non-inertial stationary or mobile thermostat/humidistat having enclosure with the openings to allow the air to flow inside of the non-inertial stationary or mobile thermostat or non-inertial stationary or mobile thermostat/humidistat, said non-inertial stationary or mobile thermostat or non-inertial stationary or mobile thermostat/humidistat having means to force the air sample from the room to flow from outside to inside of the non-inertial stationary or mobile thermostat or non-inertial stationary or mobile thermostat/humidistat enclosure and vice versa, the said forced air device flow pattern could be arranged at a constant or variable air flow, the direction and value of the said air flow can be adjusted manually or automatically; the said non-inertial stationary or mobile thermostat or non-inertial stationary or mobile thermostat/humidistat having multiple normally opened or closed switches, the said first switch serves to energize non-inertial stationary or mobile thermostat or non-inertial stationary or mobile thermostat/humidistat operation, other thermostat switches serve for room space heating/humidification and/or room space cooling mode control and also to control forced air flow sample pattern, such that when the first of the said switches is energized the said non-inertial stationary or mobile thermostat or non-inertial stationary or mobile thermostat/humidistat permanently generates first signal which is sent to the receiver/controller, the said receiver/controller, upon receiving the first signal from non-inertial stationary or mobile thermostat or non-inertial stationary or mobile thermostat/humidistat overrides control of any other mobile or stationary thermostat/humidistat on behalf of non-inertial stationary or mobile thermostat or non-inertial stationary or mobile thermostat/humidistat, the said other switches of the said non-inertial stationary or mobile thermostat or non-inertial stationary or mobile thermostat/humidistat are periodically energized when a room air temperature/humidity at the thermostat location deviates from the non-inertial stationary or mobile thermostat or non-inertial stationary or mobile thermostat/humidistat set point, as a result of energizing of one of the said switches the signal is generated, as soon as the set point deviates from the actual temperature and/or relative humidity, the signal is sent to the forced air device to energize it to force air sample from the room to flow from the outside to inside of the non-inertial stationary or mobile thermostat or non-inertial stationary or mobile thermostat/humidistat and vice versa, another signal is also sent to the receiver/controller, the said receiver/controller then sends a resultant control signal to building central heating and/or cooling system or to a room heating and/or cooling unit to change their heating and/or cooling output capacity, the switch of said non-inertial stationary or mobile thermostat or non-inertial stationary or mobile thermostat/humidistat is energized when a room air temperature at a non-inertial stationary or mobile thermostat or non-inertial stationary or mobile thermostat/humidistat location is higher than the non-inertial stationary or mobile thermostat or non-inertial stationary or mobile thermostat/humidistat high level set point temperature and/or is lower than the non-inertial stationary or mobile thermostat or non-inertial stationary or mobile thermostat/humidistat low level set point temperature, as a result of energizing of said switch the signal is generated, the said signal is sent to the forced air device to energize it to force the air sample to flow from the outside to inside of the non-inertial stationary or mobile thermostat or non-inertial stationary or mobile thermostat/humidistat and vice versa, the said signal then is sent to the receiver/controller, the said receiver/controller then sends a resultant control signal to building central heating and/or cooling system or to a room heating and/or cooling unit to reduce their output capacity, another switch of said non-inertial stationary or mobile thermostat or non-inertial stationary or mobile thermostat/humidistat is energized when a room air humidity is lower or higher than the non-inertial stationary or mobile thermostat or non-inertial stationary or mobile thermostat/humidistat low or high level set point, the said signal is sent to the forced air device to energize it to force air probe from the room to flow from the outside to inside of the non-inertial stationary or mobile thermostat or non-inertial stationary or mobile thermostat/humidistat and vice versa, the said signal then is sent to the receiver/controller, the said receiver/controller then sends a resultant control signal to building central heating humidification system or to a room heating humidification system to increase or reduce their output capacity, then the set points of the said non-inertial stationary or mobile thermostat or non-inertial stationary or mobile thermostat/humidistat are satisfied no signal will be generated and no switch will be energized and the forced air device will not be running, the said control for the forced air device can be adjusted so the said forced air device will be operable only upon the air temperature sensor signal or humidity sensor signal or both temperature and humidity sensor signals.

3. The non-inertial mobile thermostat or non-inertial mobile thermostat/humidistat wherein the claim 2 with forced air device utilizes a responsive self-adjustable control system which allows for a more accurate control of the air temperature and humidity at the occupant location, the said more accurate control is achieved when the non-inertial mobile thermostat or non-inertial mobile thermostat/humidistat is placed in vertical or horizontal position, because of the ability of the non-inertial mobile thermostat or non-inertial mobile thermostat/humidistat to take the representative air sample probe from vertical or horizontal layers of air to maximize occupants comfort with the respect to the air temperature and humidity within the close proximity to the occupant, the said improved comfort is achieved by placing the non-inertial mobile thermostat or non-inertial mobile thermostat/humidistat in the same position as the occupant is, the said non-inertial mobile thermostat or non-inertial mobile thermostat/humidistat shall be located vertically when the occupant is standing up or sitting down, the said non-inertial mobile thermostat or non-inertial mobile thermostat/humidistat shall be located horizontally when the occupant is lying down, the said forced air device allows to stabilize climate control faster to reduce the heating/cooling system cycling, the said forced air device can be set for the two modes of operation—automatic and manual, the said mode of operation of the forced air device under automatic control will energize the forced air device as soon as the non-inertial mobile thermostat or non-inertial mobile thermostat/humidistat calls for heat/humidification or cooling, the said mode of operation of the forced air device under manual control can be permanently energized or deenergized by turning it on or off.

4. The non-inertial stationary thermostat or non-inertial stationary thermostat/humidistat wherein the claim 2 uses a control system with forced air device, the said forced air device allows to vary the air temperature sample direction to provide better occupant's climate control, the said better climate control is achieved by changing the direction of the room air sample, the said room air sample can be taken from horizontal air layers or from the air layers below or above the non-inertial stationary thermostat or non-inertial stationary thermostat/humidistat or from horizontal and vertical air layers, the said forced air direction sample control device allows to stabilize climate control faster to reduce the heating/cooling system cycling, the said force air device can be set for two modes of operation—automatic and manual, the said modes of operation of the said forced air device under automatic control will energize the forced air device as soon as the non-inertial stationary thermostat or non-inertial stationary thermostat/humidistat calls for heat/humidification or cooling, the said mode of operation of the said forced air device under manual control can be permanently energized or deenergized by turning it on or off.

5. The proportionality in signal of the temperature differences between the non-inertial stationary thermostat or non-inertial mobile thermostat or non-inertial stationary thermostat/humidistat or non-inertial mobile thermostat/humidistat set point and surrounding air of claim 1 is realized via the time duration in operation of the heating/cooling system at constant heating/cooling output capacity; the said proportionality is also realized via time duration at variable output capacity of the heating/cooling system; the proportionality in signal of the humidity differences between humidistat relative humidity set point and relative humidity of the surrounding air of claim 1 is realized via the time duration during which the humidifying liquid is added to the supply distribution air, the said proportionality in signal is also realized via time duration and variation of the amount of the liquid being added to the distribution air; the said air temperature control system having means of realization of the multiple stage controls by changing heating/cooling media flow rate, changing the temperature of the heating/cooling media, changing the heating/cooling media temperature and flow rate and cycling on/off the heating/cooling system; the said control system having means of realizing control via utilization of variable frequency drives, the said variable frequency drive control which varies the speed of the furnace air distribution fan or the boiler/chiller water flow rate, etc., by increasing or reducing the air flow rate thru the variable air volume boxes, furnace, or increasing or reducing the water flow rate thru the heating/cooling coil, boilers, chillers, etc., the said control system having means of the changing the distribution air temperature via varying the fuel flow rate to the furnace; the said control system having means of turning the furnace or boiler/chiller on/off, the said control system having means to changing the position of the valve controlling the flow rate of the liquid to be added to the discharged air delivered to the room to control relative humidity level where the non-inertial stationary thermostat or non-inertial mobile thermostat or non-inertial stationary thermostat/humidistat or non-inertial mobile thermostat/humidistat is located, the said control system having means of prioritizing control with respect to air temperature and relative humidity values at the non-inertial stationary thermostat or non-inertial mobile thermostat or non-inertial stationary thermostat/humidistat or non-inertial mobile thermostat/humidistat location in such a way that the temperature or relative humidity control could be given a priority at any particular time; under the said temperature priority control, the non-inertial stationary thermostat/humidistat or mobile thermostat/humidistat will stop controlling the climate as soon as its temperature set point is satisfied; under the said temperature and relative humidity priority control cycle, the non-inertial stationary thermostat/humidistat or mobile thermostat/humidistat will continue climate control until both temperature and relative humidity set points are satisfied.

6. The non-inertial mobile thermostat or non-inertial mobile thermostat/humidistat wherein the claim 1 may have multiple channels, the said channels could be used to send temperature/humidity signal from one non-inertial mobile thermostat or non-inertial mobile thermostat/humidistat to control various zones in the same building or various areas inside the different buildings, the said channels activated or deactivated by turning the respective switch located on the non-inertial mobile thermostat or non-inertial mobile thermostat/humidistat on or off, the said channels are used to send temperature/humidity signal to the receiver/controller, the said receiver/controller having multiple channels to receive temperature or temperature/humidity signals from the non-inertial mobile thermostat or non-inertial mobile thermostat/humidistat, the control signals then are sent via controllers to the heating/cooling systems of various zones of the building or various buildings to vary their capacity in proportion to the difference in temperature/relative humidity between values of the said non-inertial mobile thermostat or non-inertial mobile thermostat/humidistat set point and the surrounding temperature/humidity to satisfy air temperature and humidity set point values at the location of the said non-inertial mobile thermostat or non-inertial mobile thermostat/humidistat.

7. The said non-inertial stationary thermostat or non-inertial mobile thermostat or non-inertial stationary thermostat/humidistat or non-inertial mobile thermostat/humidistat of claim 1 has an advisory computing system to instruct the occupant with regards to the non-inertial stationary or mobile thermostat or non-inertial stationary or mobile thermostat/humidistat set point, the said advisory computing system has base temperature set point references for heating and cooling and also indicates the locations of non-inertial stationary thermostat or non-inertial mobile thermostat or non-inertial stationary thermostat/humidistat or non-inertial mobile thermostat/humidistat inside the building, such as on the first, second, third floor, etc., of the building, the said computing system calculates and displays projected percentage of the energy savings or energy over-consumption with the relation to the base temperature set point value based on the reduction or increase in temperature set point in order to conserve energy, the said percentage in energy savings or energy over-consumption is calculated and displayed every time when the temperature set point at non-inertial stationary thermostat or non-inertial mobile thermostat or non-inertial stationary thermostat/humidistat or non-inertial mobile thermostat/humidistat is changed by the occupant.

8. The advisory computing system of claim 7 is not limited to the use in non-inertial thermostats or non-inertial thermostats/humidistats only and can be used in any programmable thermostat or programmable thermostat/humidistat to assist the occupant in selecting optimal set point parameters for building climate control system and to project percentage in energy savings and energy over-consumption in relation to the base set point parameters based on the reduction or increase in temperature set point in order to conserve energy, the said percentage in energy savings or energy over-consumption is calculated and displayed every time when the temperature set point at programmable thermostat or programmable thermostat/humidistat is changed by the occupant.
